(19) United States
(12) Patent Application Publication
(10) Pub. No.: US 2012/0188987 A1
(43) Pub. Date: Jul. 26, 2012

(54) Apparatus and Method for Facilitating Handover in TD-SCDMA Systems

(75) Inventors: Tom Chin, San Diego, CA (US); Guangming Shi, San Diego, CA (US); Kuo-Chun Lee, San Diego, CA (US)

(73) Assignee: Qualcomm Incorporated, San Diego, CA (US)

(21) Appl. No.: 13/384,167

(22) PCT Filed: May 11, 2010
(86) PCT No.: PCT/US10/34457

§ 371 Date: Jan. 13, 2012

Related U.S. Application Data
(60) Provisional application No. 61/249,337, filed on Oct. 7, 2009.

(51) Int. Cl. H04W 72/04

(52) U.S. Cl. 370/335

(57) ABSTRACT

A method and apparatus for facilitating handover in a TD-SCDMA system is provided. The method may comprise transmitting data to a serving Node B using a first set of assigned resources, and contemporaneously transmitting the data to at least one neighbor Node B using a second set of assigned resources.

### CROSS-REFERENCE TO RELATED APPLICATION(S)

This application claims the benefit of U.S. Provisional Patent Application No. 61/249,337, entitled “APPARATUS AND METHOD FOR FACILITATING HANDOVER IN TD-SCDMA SYSTEMS,” filed on Oct. 7, 2009, which is expressly incorporated by reference herein in its entirety.

### BACKGROUND

1. Field

Aspects of the present disclosure relate generally to wireless communication systems, and more particularly, to facilitate a soft handover scheme in a time division synchronous code division multiple access (TD-SCDMA) system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes transmitting data to a serving Node B using a first set of assigned resources, and contemporaneously transmitting the data to at least one neighbor Node B using a second set of assigned resources.

In an aspect of the disclosure, an apparatus includes means for transmitting data to a serving Node B using a first set of assigned resources, and means for transmitting, contemporaneously, the data to at least one neighbor Node B using a second set of assigned resources.

In an aspect of the disclosure, a computer program product includes a computer-readable medium which includes code for transmitting data to a serving Node B using a first set of assigned resources, and code for transmitting, contemporaneously, the data to at least one neighbor Node B using a second set of assigned resources.

In an aspect of the disclosure, an apparatus includes at least one processor, and a memory coupled to the at least one processor. In such an aspect, the at least one processor may be configured to transmit data to a serving Node B using a first set of assigned resources, and contemporaneously transmit the data to at least one neighbor Node B using a second set of assigned resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is an exemplary TD-SCDMA based system with multiple UEs communicating with a Node-B as time progresses, according to an aspect.

FIG. 4 is an exemplary TD-SCDMA frame structure for facilitating a soft handover like scheme according to an aspect.

FIG. 5 is a block diagram of various packet data units (PDUs) with sequence numbers according to an aspect.

FIG. 6 is a block diagram of an exemplary wireless communications device for facilitating a soft handover like scheme according to an aspect.

FIG. 7 is an exemplary block diagram of a network handover monitoring system according to an aspect.

FIG. 8 is a block diagram conceptually illustrating an example of a Node B in communication with a UE in a telecommunications system.

FIG. 9 is a functional block diagram conceptually illustrating example blocks executed to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

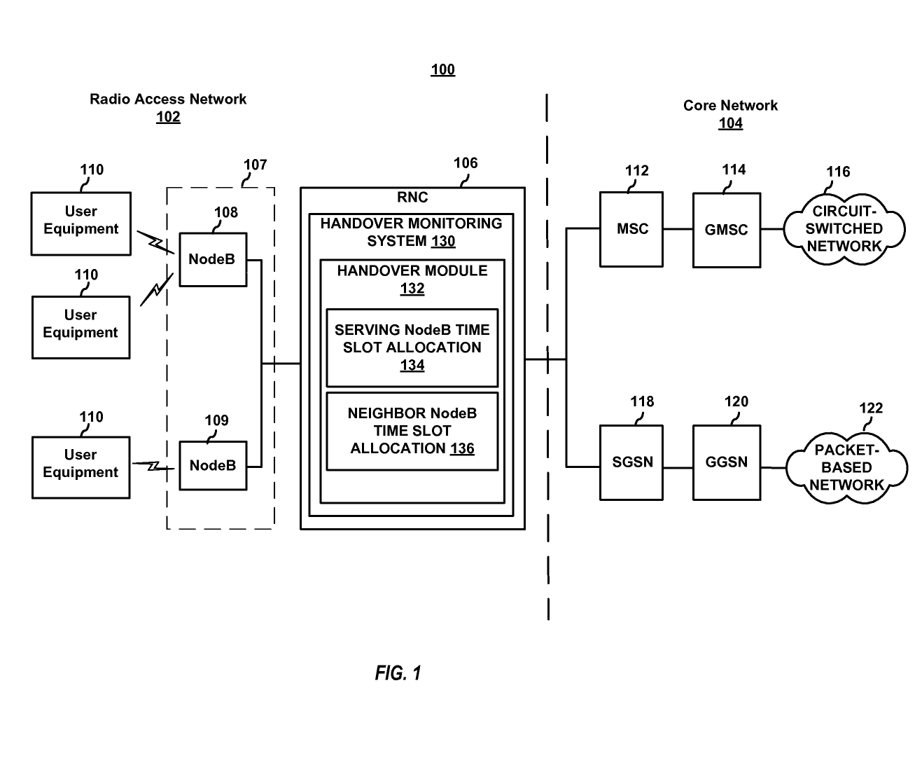

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108, 109 are shown; however, the RNS 107 may include any number of wireless Node Bs. The Node Bs 108, 109 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with at least one of the Node Bs 108, 109. The downlink (DL), also called the forward link, refers to the communication link from a Node B to a UE, and the uplink (UL), also called the reverse link, refers to the communication link from a UE to a Node B.

Further, RAN 102 may include a handover monitoring system 130 which may be operable to monitor, coordinate and/or control the Node Bs 108, 109. In one aspect, handover monitoring system 130 may be included within RNC 106, one or more servers, etc.

In one aspect, handover monitoring system 130 may further include handover module 132 which may be operable to allocate time slots for a serving Node B 108 and a neighbor Node B 109. In one aspect, handover module 132 may be operable in predefined handover regions where a UE may connect to multiple cells. In another aspect, handover module 132 may include serving Node B time slot allocation 134 and neighbor Node B time slot allocation 136 which may be operable for time allocations for DL communications from both the serving and neighboring cell in different time slots, and may further allow for UL communications to both the serving and neighboring cell in different time slots during handover. As such, a proposed time slot (TS) allocation can allow UE 110 to transmit and receive over the DPCH (Dedicated Physical Channel) in different time instance and achieve multiple links with different Node Bs 108, 109 contemporaneously, in a time division manner. Further, a time-disjointed TS allocation can reduce the complexity of UE 110 hardware. For example, the UE 110 does not need to process DL signals from more than one Node B 108, 109 at the same time, such as is required in CDMA/WCDMA soft handover. Rather, using the soft handover like scheme, processing may be serialized. Still further, performance gains from path diversity in the soft handover like scheme may be achieved as communications may not be disrupted such as during a hard handover. Also, since the UE 110 may transmit in different TSs, performance gain from time diversity may be achieved. Further, during a handover transition, UE 110 can set up both DL (tune to the receive DPCH) and UL (transmit to the DPCH) with the target Node B 109 at one time. As such, the UE 110 can measure power and timing of the Primary Common Control Physical Channel/Downlink Pilot Channel (P-CCPCH/DwPCH) and estimate a new power and timing used for UL DPCH, before the UL DPCH transmission.

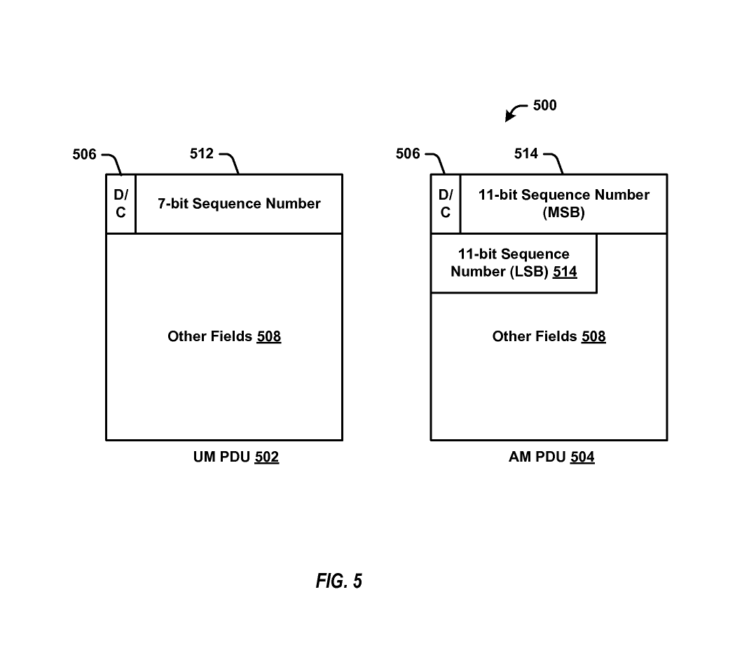

In one aspect of the RAN 102, since the UE 110 may transmit to different Node Bs 108, 109 at different times, then the UE can adjust with different UL timing to allow UL synchronization required with different Node Bs 108, 109. Further, a soft handover like scheme may allow voice/data packets of a stream to be transmitted to different Node Bs 108, 109 and possibly not within the same frame. A soft handover like scheme may use existing RLC (Radio Link Control) protocols to provide diversity combining, using functionalities such as duplication detection and packet reordering based on a sequence number. FIG. 5 depicts a sequence number for various packet data units (PDUs). As shown in FIG. 5, an Acknowledged Mode (AM) may have 11 bits of sequence number and an Unacknowledged Mode (UM) may have 7 bits of sequence number.

In operation, AM may be used for data and UM may be used for voice service. Further, in operation, each received PDU may be stored in a receive buffer of a network component (e.g., Nodes B 108, 109, RNC 106, etc.) if an earlier sequence number is not received when a later sequence number is received. The receiving RLC protocol may wait for a missing sequence number for a duration of time, after which the missing sequence number may be discarded and the sequence number window for processing the received PDUs may be updated or shifted to later sequence numbers. Additionally, or in the alternative, if a received PDU with a sequence number that has been received outside the processing window, the PDU may be discarded.

As such, with the above discussed time flexibility in sending PDUs of a stream, identical frame transmissions seen in other soft handover schemes, such as CDMA/WCDMA soft handoff, can be reduced and/or eliminated. Therefore, the above described soft handover like scheme may provide seamless handover and avoid call drop with both path diversity and time diversity. Further the scheme can provide UL synchronization, and can reduce processing loads in the UE by serializing processing.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

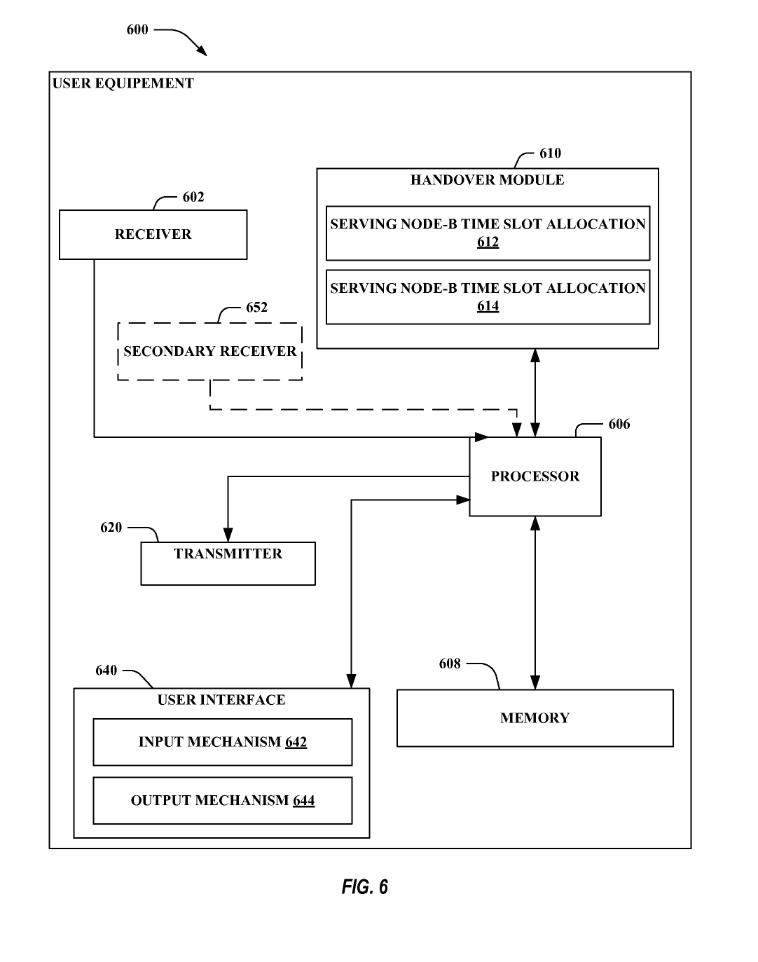

In one aspect, UE 110 may include a handover module that facilitates a soft handover like scheme, as discussed above. In one aspect, the handover module may be operable to implement allocated time slots for a serving Node B 108 and a Node B 109. Such allocations may allow the UE 110, during a soft handover like transition, to set up both the DL (tune to the receive DPCH) and the UL (transmit to the DPCH) with the target neighbor cell at one time. As such, the UE can measure power and timing of the P-CCPCH/DwPCH and estimate the new power and timing used for UL DPCH, before the UL DPCH transmission. An exemplary describe of a UE, such as UE 100 may be found with reference to FIG. 6.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

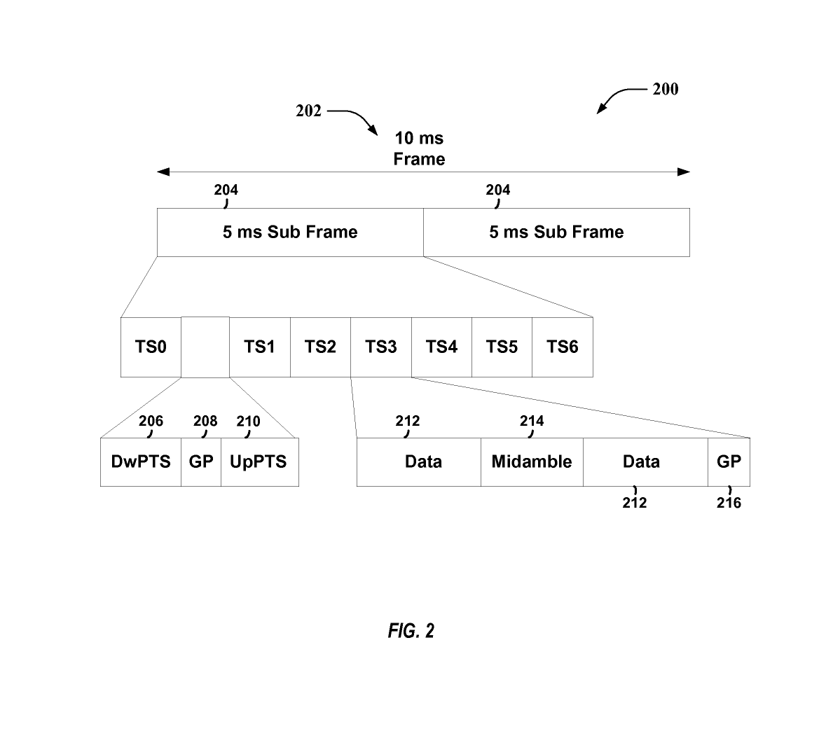

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

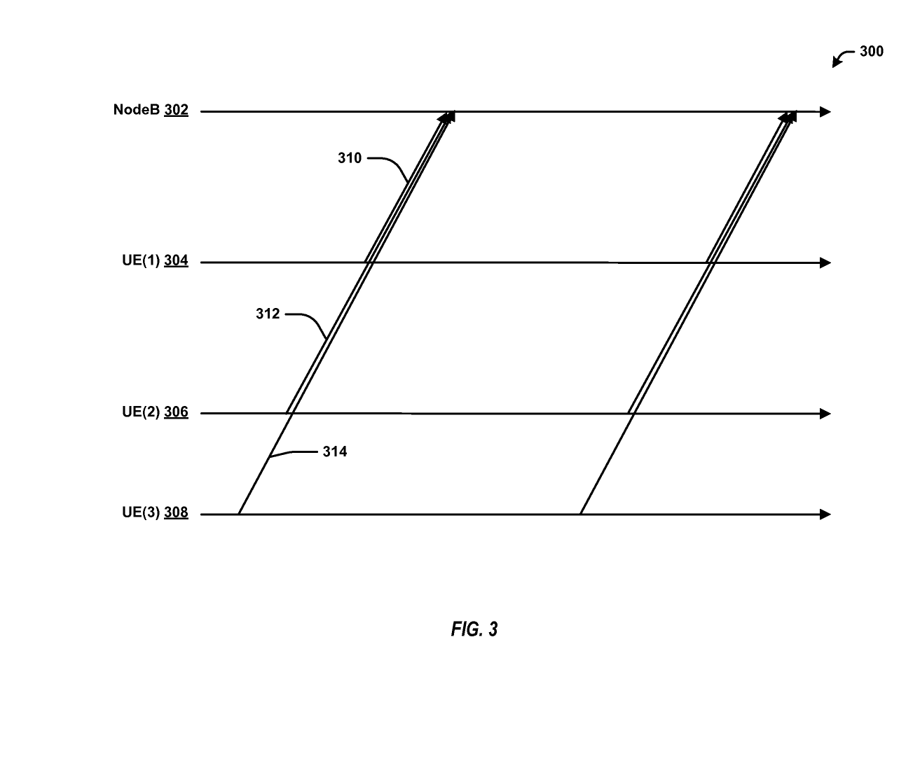

Turning now to FIG. 3, an exemplary TD-SCDMA system 300 with multiple UEs (304, 306, 308) communicating with a Node B 302, as time progresses, is illustrated. Generally, in TD-SCDMA systems, multiple UEs may share a common bandwidth in communication with a Node B, such as Node B 302. An addition aspect of TD-SCDMA systems, as compared to CDMA and WCDMA systems, is uplink (UL) synchronization. That is, in TD-SCDMA systems different UEs (304, 306, 308) may synchronize on the UL such that all signals transmitted by UEs (304, 306, 308) arrive at the Node B at approximately the same time. For example, in the depicted aspect, various UEs (304, 306, 308) are located at various distances from the serving Node B 302. Accordingly, in order for the UL transmission to reach the Node B 302 at approximately the same time, each UE may transmit at a different time. As depicted, UE 308 may be farthest from Node B 302 and may perform an UL transmission 314 before closer UEs. Additionally, UE 306 may be closer to Node B 302 than UE 308 and may perform an UL transmission 312 after UE 308. Similarly, UE 304 may be still closer to Node B 302 and may perform an UL transmission 310 after UEs 306 and 308. The timing of the UL transmissions (310, 312, 314) may be such that the signals arrive at the Node B at approximately the same time.

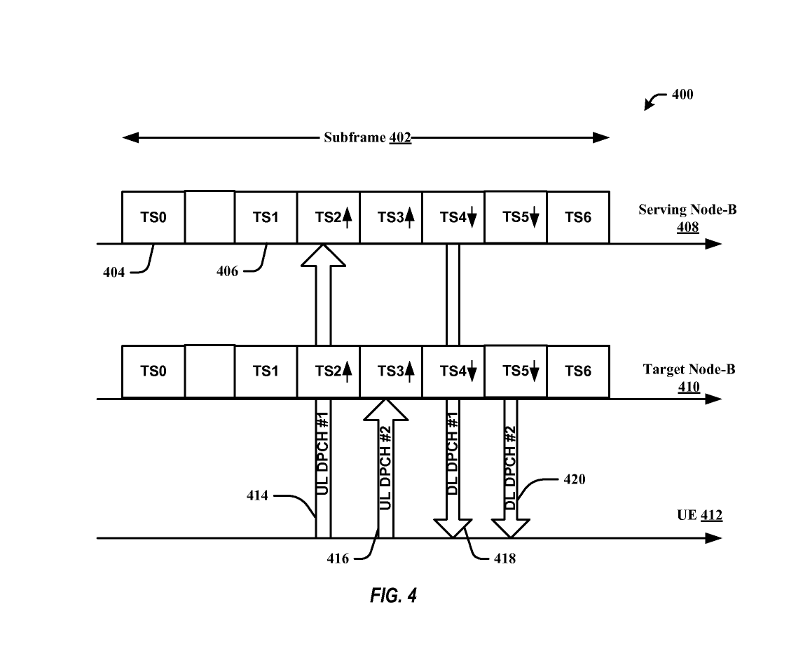

With reference now to FIG. 4, an exemplary TD-SCDMA frame structure 400 for facilitating a soft handover like scheme is illustrated. Generally, a frame, as depicted with reference to FIG. 2, may include two subframes 402, and each subframe 402 may include 7 time slots. Within these 7 times slots, certain defined time slots may be used for DL communications 404 and other defined time slots may be used for UL communications 406. In a TD-SCDMA system, one assumption may further be that frame timing of a serving Node B 408 is substantially synchronized with the frame timing for a neighboring target Node B (e.g., neighbor Node B) 410. As such, during implementation of a soft handover like scheme, UE 412 may receive DL communications using different time slots for different Node Bs, and may transmit UL communications using different time slots for different Node Bs. For example, UE 412 may communicate over the UL dedicated physical channel (DPCH) 414 with a serving Node B 408 at TS2 and may communicate over the UL-DPCH 416 with a target Node B 410 at TS3. Thereafter, at TS4 the serving Node B 408 may communicate over the DL DPCH 418 to the UE 412 and at TS5 the neighbor Node B 410 may communicate over DL DPCH 420 to the UE 412. Such a timeslot allocation may allow UE 412 to transmit and receive over the DPCH in different time instance to different Node Bs and therefore achieve multiple contemporaneous links with different Node B in a time division manner.

Turning now to FIG. 5, various packet data units (PDUs) 500 with associated sequence numbers are depicted according to an aspect. Generally, using a soft handover like scheme, a UE can transmit to different Node Bs at different times, and the UE can adjust with different UL timing to allow UL synchronization required with different Node Bs. Further, the soft handover like scheme may allow voice/data packets of a stream to be transmitted to different Node Bs and possibly not within the same frame. The soft handover like scheme may use existing RLC (Radio Link Control) protocols to provide diversity combining using functionalities such as duplication detection and packet reordering based on a sequence number.

As shown in FIG. 5, an Acknowledged Mode (AM) 504 PDU has 11 bits of sequence number 514 and Unacknowledged Mode (UM) 502 has 7 bits of sequence number 512. Further, both PDUs may include a data/control field 506 and other fields 508. In operation, AM PDUs 504 may be used for data and UM PDUs 502 may be used for voice service. Further, in operation, each received PDU may be stored in a receive buffer of a network component (e.g., base station 110, RNC 130, etc.) if an earlier sequence number (512, 514) is not received when a later sequence number (512, 514) is received. The receiving RLC protocol can wait for the missing sequence number (512, 514) for a duration of time, after which the missing sequence number (512, 514) may be ignored and the sequence number window for processing received PDUs may be updated or shifted to later sequence numbers (512, 514). Additionally, or in the alternative, if a received PDU with a sequence number (512, 514) that has been received outside the processing window, the PDU may be discarded.

With reference now to FIG. 6, an illustration of a user equipment (UE) 600 (e.g., a client device, wireless communications device (WCD), etc.) that can facilitate a soft handover like scheme is presented. UE 600 comprises receiver 602 that receives one or more signal from, for instance, one or more receive antennas (not shown), performs typical actions on (e.g., filters, amplifies, downconverts, etc.) the received signal, and digitizes the conditioned signal to obtain samples. Receiver 602 can further comprise an oscillator that can provide a carrier frequency for demodulation of the received signal and a demodulator that can demodulate received symbols and provide them to processor 606 for channel estimation. In one aspect, client device 600 may further comprise secondary receiver 652 and may receive additional channels of information.

Processor 606 can be a processor dedicated to analyzing information received by receiver 602 and/or generating information for transmission by one or more transmitters 620 (for ease of illustration, only one transmitter is shown), a processor that controls one or more components of UE 600, and/or a processor that both analyzes information received by receiver 602 and/or secondary receiver 652, generates information for transmission by transmitter 620 for transmission on one or more transmitting antennas (not shown), and controls one or more components of UE 600.

UE 600 can additionally comprise memory 608 that is operatively coupled to processor 606 and that can store data to be transmitted, received data, information related to available channels, data associated with analyzed signal and/or interference strength, information related to an assigned channel, power, rate, or the like, and any other suitable information for estimating a channel and communicating via the channel. Memory 608 can additionally store protocols and/or algorithms associated with estimating and/or utilizing a channel (e.g., performance based, capacity based, etc.).

It will be appreciated that the data store (e.g., memory 608) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods is intended to comprise, without being limited to, these and any other suitable types of memory.

UE 600 can further include handover module 610 that facilitates a soft handover like scheme for the UE 600. In one aspect of the UE 600, handover module 610 may be operable to implement allocated time slots for a serving base station 612 and a neighbor base station 614. Such allocations may allow the UE 600, during a soft handover like transition, the UE 600 can set up both the DL (tune to the receive DPCH) and the UL (transmit to the DPCH) with the target neighbor cell at one time. As such, the UE can measure power and timing of the P-CCPCH/DwPCH and estimate the new power and timing used for UL DPCH, before the UL DPCH transmission

Additionally, UE 600 may include user interface 640. User interface 640 may include input mechanisms 642 for generating inputs into UE 600, and output mechanism 644 for generating information for consumption by the user of wireless device 600. For example, input mechanism 642 may include a mechanism such as a key or keyboard, a mouse, a touch-screen display, a microphone, etc. Further, for example, output mechanism 644 may include a display, an audio speaker, a haptic feedback mechanism, a Personal Area Network (PAN) transceiver etc. In the illustrated aspects, output mechanism 644 may include a display operable to present content that is in image or video format or an audio speaker to present content that is in an audio format.

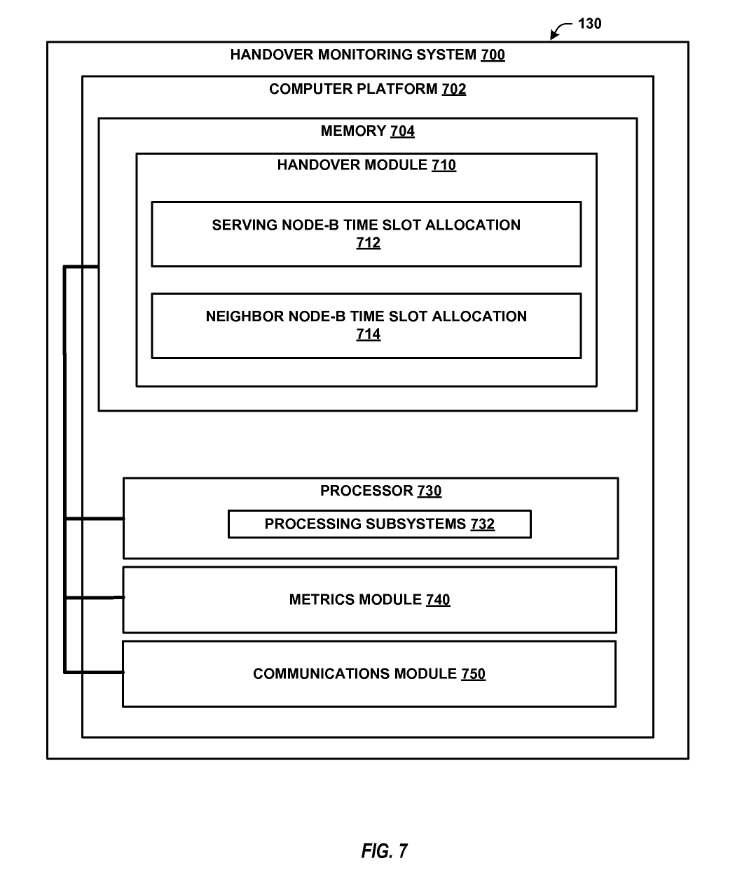

With reference to FIG. 7, illustrated is a detailed block diagram of handover monitoring system 700, such as handover monitoring system 130 depicted in FIG. 1. Handover monitoring system 700 may comprise at least one of any type of hardware, server, personal computer, mini computer, mainframe computer, or any computing device either special purpose or general computing device. Further, the modules and applications described herein as being operated on or executed by handover monitoring system 700 may be executed entirely on a single network device, as shown in FIG. 7, or alternatively, in other aspects, separate servers, databases or computer devices may work in concert to provide data in usable formats to parties, and/or to provide a separate layer of control in the data flow between UEs 110, Node Bs 108, 109, and the modules and applications executed by handover monitoring system 700.

Handover monitoring system 700 includes computer platform 702 that can transmit and receive data across wired and wireless networks, and that can execute routines and applications. Computer platform 702 includes memory 704, which may comprise volatile and nonvolatile memory such as read-only and/or random-access memory (ROM and RAM), EPROM, EEPROM, flash cards, or any memory common to computer platforms. Further, memory 704 may include one or more flash memory cells, or may be any secondary or tertiary storage device, such as magnetic media, optical media, tape, or soft or hard disk. Still further, computer platform 702 also includes processor 730, which may be an application-specific integrated circuit (“ASIC”), or other chipset, logic circuit, or other data processing device. Processor 730 may include various processing subsystems 732 embodied in hardware, firmware, software, and combinations thereof, that enable the functionality of handover module 710 and the operability of the network device on a wired or wireless network.

Computer platform 702 further includes communications module 750 embodied in hardware, firmware, software, and combinations thereof that enables communications among the various components of handover monitoring system 700, as well as between handover monitoring system 700 and Node Bs 108, 109. Communication module 750 may include the requisite hardware, firmware, software and/or combinations thereof for establishing a wireless communication connection. According to described aspects, communication module 750 may include hardware, firmware and/or software to facilitate wireless broadcast, multicast and/or unicast communication of requested cell. Node B, UE, etc., measurements.

Computer platform 702 further includes metrics module 740, embodied in hardware, firmware, software, and combinations thereof, that enables metrics received from Node Bs 108, 109 corresponding to, among other things, data communicated from UEs 110. In one aspect, handover monitoring system 700 may analyze data received through metrics module 740 and may monitor network and/or UE, health, capacity, usage, etc. For example, if the metrics module 740 returns data indicating that one or more of a plurality of Node Bs are inefficient, then the handover monitoring system 700 may allocate time slots so as to allow UEs to perform a soft handover like transfer away from said inefficient Node B.

Memory 704 of handover monitoring system 700 includes network handover module 710 operable for assisting in network facilitating a soft handover like scheme. In one aspect, handover module 710 may be operable to allocate time slots for a serving Node B 712 and a neighbor node B 714. In one aspect, handover module may be operable in predefined handover regions where a UE may connect to multiple cells. In another aspect, the time allocations may allow for DL communications from both the serving and neighboring cell in different time slots, and my further allow for UL communications to both the serving and neighboring cell in different time slots during handover. Such allocation allow a UE, during implementation of the soft handover like scheme, to DL communicate using different time slots for different cells, and may UL communicate using different time slots for different cells.

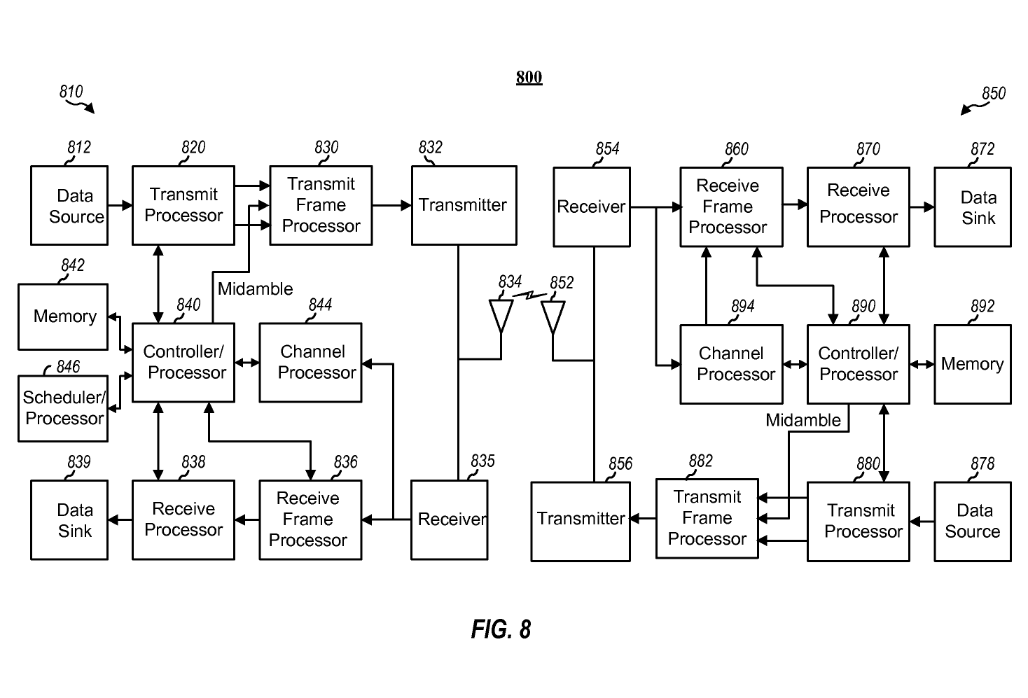

FIG. 8 is a block diagram of a Node B 810 in communication with a UE 850 in a RAN 800, where the RAN 800 may be the RAN 102 in FIG. 1, the Node B 810 may be the Node B 108 in FIG. 1, and the UE 850 may be the UE 110 in FIG. 1. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback contained in the midamble 214 (FIG. 2) from the UE 850. The symbols generated by the transmit processor 820 are provided to a transmit frame processor 830 to create a frame structure. The transmit frame processor 830 creates this frame structure by multiplexing the symbols with a midamble 214 (FIG. 2) from the controller/processor 840, resulting in a series of frames. The frames are then provided to a transmitter 832, which provides various signal conditioning functions including amplifying, filtering, and modulating the frames onto a carrier for downlink transmission over the wireless medium through smart antennas 834. The smart antennas 834 may be implemented with beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides the midamble 214 (FIG. 2) to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. In one aspect, transmit processor 880 may include a handover module that facilitates a soft handover like scheme, as discussed above. In one aspect, the handover module may be operable to implement allocated time slots for a serving Node B 108 and a Node B 109. Such allocations may allow the UE 110, during a soft handover like transition, to set up both the DL (tune to the receive DPCH) and the UL (transmit to the DPCH) with the target neighbor cell at one time. As such, the UE can measure power and timing of the P-CCPCH/DwPCH and estimate the new power and timing used for UL DPCH, before the UL DPCH transmission. In such an aspect, the transmit processor 880 may be configured to transmit data to a serving Node B using a first set of assigned resources, and contemporaneously transmit the data to at least one neighbor Node B using a second set of assigned resources.

Further, channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with a midamble 214 (FIG. 2) from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides the midamble 214 (FIG. 2) to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

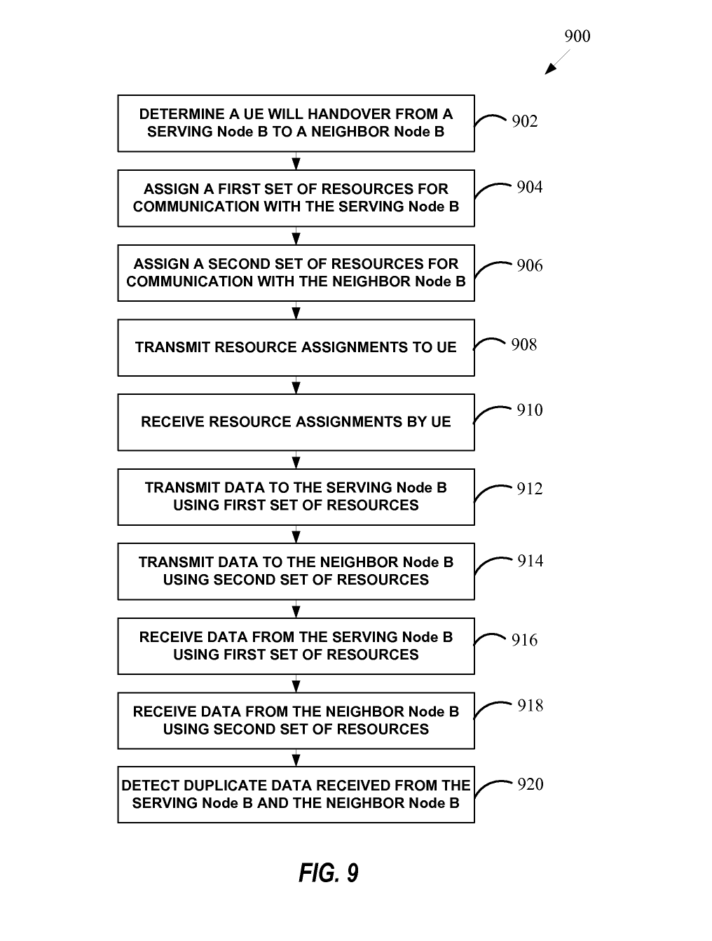

FIG. 9 is a functional block diagram 900 illustrating example blocks executed in conducting wireless communication in TD-SCDMA system according to one aspect of the present disclosure. In block 902, a determination is made that a UE will handover service from a serving node B to a neighbor Node B. In one aspect, such a determination may be performed by a radio network controller. In another aspect, the determination may be performed when a UE is located in a geographic region in which a soft handover like scheme is operable and where the UE can communicate with at least two Node Bs. In yet another aspect, the determination may include determining whether a serving Node B and a neighbor Node B have frame boundaries which are aligned within a threshold. In addition, in block 904 a first set of resources maybe assigned for communication between the serving Node B and the UE. Furthermore, in block 906 a second set of resources maybe assigned for communication between the neighbor Node B and the UE. In one aspect, the resources may include assigned time slots for communication. In such an aspect, the first set of resources may include assigning time slot 2 for the uplink communications and time slot 4 for the downlink communications, and the second set of resources may include time slot 3 for the uplink communications and time slot 5 for the downlink communications. In block 908, the resource assignment sets may be transmitted to the UE. In one aspect, the serving Node B may transmit the resource assignments to the UE.

Additionally, or optionally, in block 910, the transmitted resource assignment sets may be received by the UE. In block 912, UE may transmit data to the serving Node B using the first set of resource assignments. In block 914, the UE may transmit data to the neighbor Node B using the second set of resource assignments. In one aspect, the data may include at least one packet data unit, wherein each packet data unit has an associated sequence number. In such an aspect, the associated sequence numbers may include at least one of: an Acknowledged Mode (AM) PDU with 11 bits for a sequence number, an Unacknowledged Mode (UM) PDU with 7 bits for a sequence number, etc. In one aspect, the data is transmitted using a dedicated physical channel.

In block 916, the UE may further receive data from the serving Node B using the first set of resources. In block 918, the UE may also further receive data from the neighbor Node B using the second set of resources. In block 920, the received data may be analyzed and duplicate data may be detected. In one aspect, detecting duplicate data may include determining a sequence number associated with at least a portion of the data received from the serving Node B matches a sequence number associated with at least a portion of the data received from the neighbor Node B.

In one configuration, the apparatus 850 for wireless communication includes means for transmitting data to a serving Node B using a first set of assigned resources and means for transmitting, contemporaneously, the data to at least one neighbor Node B using a second set of assigned resources. In one aspect, the aforementioned means may be the processor(s) 880, 882, 890 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division synchronous code division multiple access (TD-SCDMA) system, comprising:
transmitting data to a serving Node B using a first set of assigned resources; and
transmitting, contemporaneously, the data to at least one neighbor Node B using a second set of assigned resources.

2. The method of claim 1, further comprising:
receiving the first set of assigned resources and the second set of assigned recourses from the serving Node B, wherein the resource sets are assigned by a radio network controller (RNC) associated with the serving Node B and the neighbor Node B.

3. The method of claim 2, wherein the RNC assigns the resource sets when a UE is located in a geographic region where the UE can communicate with both the serving Node B and the neighbor Node B.

4. The method of claim 1, further comprising:
receiving data from the serving Node B using the first set of assigned resources;
receiving data from the neighbor Node B using the second set of assigned resources; and
detecting duplicate data from the data received from the serving Node B and the data received from the neighbor Node B.

5. The method of claim 4, wherein the duplicate data detection further comprises:
determining a sequence number associated with at least a portion of the data received from the serving Node B matches a sequence number associated with at least a portion of the data received from the neighbor Node B.

6. The method of claim 1, wherein the data comprises at least one packet data unit, wherein each packet data unit has an associated sequence number.

7. The method of claim 6, wherein the associated sequence numbers includes at least one of: an Acknowledged Mode (AM) PDU with 11 bits for a sequence number, or an Unacknowledged Mode (UM) PDU with 7 bits for a sequence number.

8. The method of claim 1, wherein the transmissions comprising transmitting using a dedicated physical channel.

9. The method of claim 1, wherein the serving Node B and the neighbor Node B have resource frame boundaries which are aligned within a threshold.

10. The method of claim 1, wherein the first set of resources comprises a time slot 2 for the uplink communications and a time slot 4 for the downlink communications, and wherein the second set of resources comprises a time slot 3 for the uplink communications and a time slot 5 for the downlink communications.

11. An apparatus for wireless communication in a time division synchronous code division multiple access (TD-SCDMA) system, comprising:
means for transmitting data to a serving Node B using a first set of assigned resources; and
means for transmitting, contemporaneously, the data to at least one neighbor Node B using a second set of assigned resources.

12. The apparatus of claim 11, further comprising:
means for receiving the first set of assigned resources and the second set of assigned recourses from the serving Node B, wherein the resource sets are assigned by a radio network controller (RNC) associated with the serving Node B and the neighbor Node B.

13. The apparatus of claim 12, wherein the RNC assigns the resource sets when a UE is located in a geographic region where the UE can communicate with both the serving Node B and the neighbor Node B.

14. The apparatus of claim 11, further comprising:
means for receiving data from the serving Node B using the first set of assigned resources;
means for receiving data from the neighbor Node B using the second set of assigned resources; and
means for detecting duplicate data from the data received from the serving Node B and the data received from the neighbor Node B.

15. The apparatus of claim 14, wherein the means for duplicate data detection further comprises:
means for determining a sequence number associated with at least a portion of the data received from the serving Node B matches a sequence number associated with at least a portion of the data received from the neighbor Node B.

16. The apparatus of claim 11, wherein the data comprises at least one packet data unit (PDU), wherein each PDU has an associated sequence number.

17. The apparatus of claim 16, wherein the associated sequence numbers includes at least one of: an Acknowledged Mode (AM) PDU with 11 bits for a sequence number, or an Unacknowledged Mode (UM) PDU with 7 bits for a sequence number.

18. The apparatus of claim 11, wherein the transmissions comprising transmitting using a dedicated physical channel.

19. The apparatus of claim 11, wherein the serving Node-B and the neighbor Node-B have resource frame boundaries which are aligned within a threshold.

20. The apparatus of claim 11, wherein the first set of resources comprises a time slot 2 for the uplink communications and a time slot 4 for the downlink communications, and wherein the second set of resources comprises a time slot 3 for the uplink communications and a time slot 5 for the downlink communications.

21. A computer program product, comprising:
a computer-readable medium comprising code for:
transmitting data to a serving Node B using a first set of assigned resources; and
transmitting, contemporaneously, the data to at least one neighbor Node B using a second set of assigned resources.

22. The computer program product of claim 21, wherein the computer-readable medium further comprises code for:
receiving the first set of assigned resources and the second set of assigned recourses from the serving Node B, wherein the resource sets are assigned by a radio network controller (RNC) associated with the serving Node B and the neighbor Node B.

23. The computer program product of claim 22, wherein the RNC assigns the resource sets when a user equipment (UE) is located in a geographic region where the UE can communicate with both the serving Node B and the neighbor Node B.

24. The computer program product of claim 21, wherein the computer-readable medium further comprises code for:
receiving data from the serving Node B using the first set of assigned resources;
receiving data from the neighbor Node B using the second set of assigned resources; and
detecting duplicate data from the data received from the serving Node B and the data received from the neighbor Node B.

25. The computer program product of claim 24, wherein the computer-readable medium further comprises code for:
determining a sequence number associated with at least a portion of the data received from the serving Node B matches a sequence number associated with at least a portion of the data received from the neighbor Node B.

26. The computer program product of claim 21, wherein the data comprises at least one packet data unit, wherein each packet data unit has an associated sequence number.

27. The computer program product of claim 26, wherein the associated sequence numbers includes at least one of: an Acknowledged Mode (AM) PDU with 11 bits for a sequence number, or an Unacknowledged Mode (UM) PDU with 7 bits for a sequence number.

28. The computer program product of claim 21, wherein the computer-readable medium further comprises code for transmitting using a dedicated physical channel.

29. The computer program product of claim 21, wherein the serving Node-B and the neighbor Node-B have resource frame boundaries which are aligned within a threshold.

30. The computer program product of claim 21, wherein the first set of resources comprises a time slot 2 for the uplink communications and a time slot 4 for the downlink communications, and wherein the second set of resources comprises a time slot 3 for the uplink communications and a time slot 5 for the downlink communications.

31. An apparatus for wireless communication in a time division synchronous code division multiple access (TD-SCDMA) system, comprising:
at least one processor; and
a memory coupled to the at least one processor,
wherein the at least one processor is configured to:
transmit data to a serving Node B using a first set of assigned resources; and
transmit, contemporaneously, the data to at least one neighbor Node B using a second set of assigned resources.

32. The apparatus of claim 31, wherein the at least one processor is further configured to:
receive the first set of assigned resources and the second set of assigned recourses from the serving Node B, wherein the resource sets are assigned by a radio network controller (RNC) associated with the serving Node B and the neighbor Node B.

33. The apparatus of claim 32, wherein the RNC assigns the resource sets when a user equipment (UE) is located in a geographic region where the UE can communicate with both the serving Node B and the neighbor Node B.

34. The apparatus of claim 31, wherein the at least one processor is further configured to:
receive data from the serving Node B using the first set of assigned resources;
receive data from the neighbor Node B using the second set of assigned resources; and
detect duplicate data from the data received from the serving Node B and the data received from the neighbor Node B.

35. The apparatus of claim 34, wherein the at least one processor is further configured to:
determine a sequence number associated with at least a portion of the data received from the serving Node B matches a sequence number associated with at least a portion of the data received from the neighbor Node B.

36. The apparatus of claim 31, wherein the data comprises at least one packet data unit, wherein each packet data unit has an associated sequence number.

37. The apparatus of claim 36, wherein the associated sequence numbers includes at least one of: an Acknowledged Mode (AM) PDU with 11 bits for a sequence number, or an Unacknowledged Mode (UM) PDU with 7 bits for a sequence number.

38. The apparatus of claim 31, wherein the at least one processor is further configured to:
transmit using a dedicated physical channel.

39. The apparatus of claim 31, wherein the serving Node-B and the neighbor Node-B have resource frame boundaries which are aligned within a threshold.

40. The apparatus of claim 31, wherein the first set of resources comprises a time slot 2 for the uplink communications and a time slot 4 for the downlink communications, and wherein the second set of resources comprises a time slot 3 for the uplink communications and a time slot 5 for the downlink communications.
